(19) United States
(12) Patent Application Publication
(10) Pub. No.: US 2025/0346505 A1
(43) Pub. Date: Nov. 13, 2025

(54) ELECTROLYZER WITH DYNAMIC MEMBRANE

(71) Applicants: Pieter Willem Herman DE JAGER, Middelbeers (NL); Aukje Arianne Annette KASTELIJN, Schiedam (NL)

(72) Inventors: Pieter Willem Herman DE JAGER, Middelbeers (NL); Aukje Arianne Annette KASTELIJN, Schiedam (NL)

(73) Assignee: ASML NETHERLANDS B.V., Veldhoven (NL)

(21) Appl. No.: 18/867,540

(22) PCT Filed: Jul. 6, 2023
(86) PCT No.: PCT/EP2023/068723

§ 371 Date: Nov. 20, 2024

(30) Foreign Application Priority Data
Jul. 28, 2022 (EP) 22187647.7

(51) Int. Cl. C02F 1/461; C02F 103/08; C25B 1/04; C25B 13/02; C25B 15/08

(52) U.S. Cl. CPC C02F 1/46104; C25B 1/04; C25B 13/02; C25B 15/083; C02F 2103/08; C02F 2201/4611; C02F 2201/46145; C02F 2301/022

(57) ABSTRACT

An electrolyzer that includes an anode configured for being connected to a first pole of a voltage source; a cathode configured for being connected to a second pole of the voltage source; a fluid inlet configured to allow a flow of fluid to enter the electrolyzer; and a fluid outlet configured to allow the flow to exit the electrolyzer, wherein the electrolyzer is configured to cause the flow to have a flow speed profile along a flow axis with a relatively higher flow speed at the flow axis between the anode and the cathode, wherein the flow speed becomes relatively lower at locations away from the flow axis and more proximate the anode and the cathode, and wherein the electrolyzer has an entrance length that causes the flow speed profile to be at least a partially developed laminar flow when the flow reaches the anode or the cathode.

### CROSS-REFERENCE TO RELATED APPLICATIONS

This application claims priority of EP application 22187647.7 which was filed on Jul. 28, 2022 and which is incorporated herein in its entirety by reference.

### TECHNICAL FIELD

The description herein relates generally to electrolyzers for separating fluid constituents. More particularly, the disclosure includes compact and efficient electrolyzers that utilize dynamic membranes and other design features to obtain improved fluid output.

### BACKGROUND

Electrolyzers can be used to split water into hydrogen and oxygen gas by applying an electric field between a cathode and an anode. In recent years, the interest in electrolyzers has gained interest significantly because of the envisioned role of hydrogen in the energy transition. Meanwhile, hydrogen from an electrolyzer (called “green hydrogen”) can be used as ingredient for chemical processes such as production of fertilizers. State-of-the-art for such applications is “grey hydrogen” made from natural gas (CH4).

### SUMMARY

Systems including electrolyzers are disclosed. In one aspect, a system comprising an electrolyzer includes an anode configured for being connected to a first pole of a voltage source; a cathode configured for being connected to a second pole of the voltage source; a fluid inlet configured to allow a flow of fluid to enter the electrolyzer; and a fluid outlet configured to allow the flow to exit the electrolyzer, the electrolyzer configured to cause the flow to have a flow speed profile along a flow axis with a relatively higher flow speed at the flow axis between the anode and the cathode, and wherein the flow speed becomes relatively lower at locations away from the flow axis and more proximate the anode and the cathode, wherein the electrolyzer has an entrance length that causes the flow speed profile to be at least a partially developed laminar flow when the flow reaches the anode or the cathode.

In some variations, the flow speed profile can be a partially developed laminar flow or a fully developed laminar flow.

In some variations, a cathode fluid guide can be configured to direct the flow proximate the cathode to a first fluid outlet; and an anode fluid guide can be configured to direct the flow proximate the anode to a second fluid outlet. The fluid outlet can include a first fluid outlet and a second fluid outlet, the first fluid outlet disposed in the electrolyzer to receive the flow proximate the cathode, the second outlet disposed in the electrolyzer to receive the flow proximate the anode. The first fluid outlet and the second fluid outlet can be disposed in a longitudinal direction of the electrolyzer. The fluid outlet can further comprise a third fluid outlet with the second fluid outlet and the third fluid outlet disposed on either side of the first fluid outlet.

In some variations, the electrolyzer can be elongate and substantially thinner in a transverse direction to the flow than in a longitudinal direction. The anode and the cathode can have a separation of between 0.5 and 12 mm. The separation can be between 1 mm and 3 mm. The electrolyzer can have a height of between 10 mm and 70 mm along the flow axis. The anode and/or the cathode can have a surface profile that is not flat. The surface profile can include ripples that are perpendicular to the flow of fluid.

In some variations, the fluid can be seawater and the electrolyzer produces a first fluid output that has a saltwater content reduced from a second fluid outlet by the separation of salt in the fluid utilizing the anode and the cathode.

In an interrelated aspect, an electrolyzer can include: an anode configured for being connected to a first pole of a voltage source; a cathode configured for being connected to a second pole of the voltage source; a fluid inlet configured to allow a flow of fluid to enter the electrolyzer; and a fluid outlet configured to allow the flow to exit the electrolyzer, the electrolyzer configured to cause the flow to have a flow speed profile along a flow axis with a relatively higher flow speed at the flow axis between the anode and the cathode, and wherein the flow speed becomes relatively lower at locations away from the flow axis and more proximate the anode and the cathode, the electrolyzer further comprising a separator configured to direct a first fluid output to a first fluid outlet and a second fluid output to a second fluid outlet, wherein the separator extends parallel to the flow axis and has an upstream edge terminating at approximately at a downstream anode edge of the anode or at approximately a downstream cathode edge of the cathode such that the separator causes at least partial separation of the flow.

In some variations, the upstream edge of the separator can be proximate to, and downstream of, the downstream cathode edge or the downstream anode edge. The separator can be a knife edge that includes a sharp edge to facilitate separating the fluid.

In an interrelated aspect, a plurality of electrolyzers are arranged in a parallel stack, each of the plurality of electrolyzers comprising: an anode configured for being connected to a first pole of a voltage source; a cathode configured for being connected to a second pole of the voltage source; a fluid inlet configured to allow a flow of fluid to enter the electrolyzer; and a fluid outlet configured to allow the flow to exit the electrolyzer, the electrolyzer configured to cause the flow to have a flow speed profile along a flow axis with a relatively higher flow speed at the flow axis between the anode and the cathode, and wherein the flow speed becomes relatively lower at locations away from the flow axis and more proximate the anode and the cathode, the system configured to: receive portions of an input flow of the fluid from a common fluid input source to the fluid inlet of each of the plurality of electrolyzers; output a first fluid output from a first fluid outlet in each of the plurality of electrolyzers; and output a second fluid output from a second fluid outlet in each of the plurality of electrolyzers.

In some variations, the first fluid outlet and the second fluid outlet can be configured to direct the flow in a same direction parallel to a stacking direction of the parallel stack. The system can be configured to cause the first fluid outlet and the second fluid outlet to direct the first fluid output and second fluid output in different directions parallel to a stacking direction of the parallel stack. The system can further include a second parallel stack, wherein the system is further configured to provide the first fluid output and/or second fluid output from the parallel stack to a fluid inlet of an electrolyzer in the second parallel stack.

In an interrelated aspect, an electrolyzer can include: an anode configured for being connected to a first pole of a voltage source; a cathode configured for being connected to a second pole of the voltage source; a fluid inlet configured to allow a flow of fluid to enter the electrolyzer; and a fluid outlet configured to allow the flow to exit the electrolyzer, the electrolyzer configured to cause the flow to have a flow speed profile along a flow axis with a relatively higher flow speed at the flow axis between the anode and the cathode, and wherein the flow speed becomes relatively lower at locations away from the flow axis and more proximate the anode and the cathode, wherein the electrolyzer is constructed operate at a fluid pressure above 1 bar and at a temperature above 25 C that does not exceed the boiling point of the fluid at a fluid pressure.

In some variations, the electrolyzer can be constructed to operate at the temperature being at least 100 C. The electrolyzer can be constructed to operate at the temperature being at least 200 C. The electrolyzer can be constructed to operate at the fluid pressure being between 20-30 Bar to keep the fluid from boiling.

In some variations, the system can be connected to a power source including one or more of a solar panel, a wind turbine, a water turbine, or a wave energy capture system. The electrolyzer can be configured to de-energize the anode and/or the cathode within 10 seconds of turning off a power source that energizes the anode and the cathode. The system can be configured to cut power to the anode and/or the cathode when a power source providing power to the anode and/or the cathode is interrupted. The system can be configured to halt the flow of fluid through the electrolyzer when a power source providing power to the anode and/or the cathode is interrupted for at least a first period of time. The first period of time can be at least 10 minutes. The system can be configured to halt heating of the electrolyzer when a power source providing power to the anode and/or the cathode is interrupted for at least a second period of time. The second period of time can be at least two hours. The system can be configured to utilize an alternative power source to energize the anode and/or the cathode when a power source providing power to the anode and/or the cathode is interrupted.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram of a simplified electrolyzer.

FIG. 2 is a diagram of a fluid flow evolving from a constant flow profile to a fully developed laminar flow.

FIG. 3 is a diagram of an electrolyzer, according to an embodiment of the present disclosure.

FIG. 4 is a diagram of a cathode side view of an electrolyzer illustrating fluid outlet guides over the cathode, according to an embodiment of the present disclosure.

FIG. 5 is a diagram of an anode side view of an electrolyzer illustrating fluid outlet guides over the anode, according to an embodiment of the present disclosure.

FIG. 6 is a diagram of a separator, according to an embodiment of the present disclosure.

FIG. 7 is a diagram of a separator, according to another embodiment of the present disclosure.

FIG. 8 is a diagram of electrolyzers arranged in a parallel stack, according to an embodiment of the present disclosure.

### DETAILED DESCRIPTION

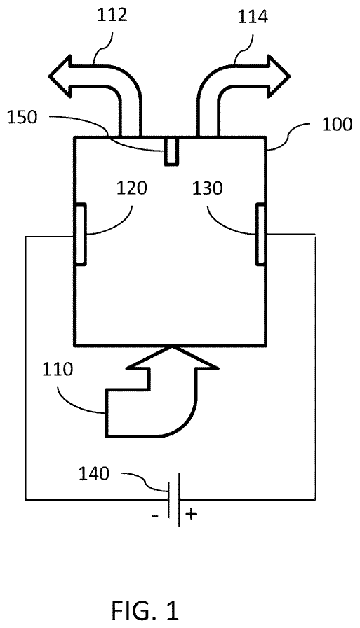

FIG. 1 is a diagram of a simplified electrolyzer. Electrolyzers (e.g., electrolyzer 100) can be used to split water 110 into fluids containing, e.g., a higher concentration of hydrogen 112 or oxygen 114 by applying an electric field between cathode 120 and anode 130. The electric field can be generated by power source 140 that can generate a potential difference between cathode 120 and anode 130. Some electrolyzers can be referred to as alkaline where an OH− ion crosses from cathode to anode. Other electrolyzers can be referred to as acid where an H+ ion crosses from anode 130 to cathode 120. Some electrolyzers can include separator 150 generally between cathode 120 and anode 130 that can act to separate the hydrogen and oxygen gasses suspended in the output fluids.

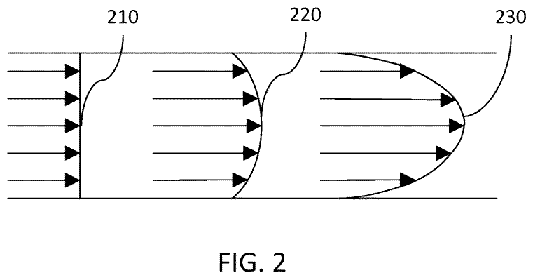

FIG. 2 is a diagram of a fluid flow evolving from a constant flow profile to a fully developed laminar flow. As a fluid (e.g., fresh water, sea water, etc.) flows through an electrolyzer, the flow profile can evolve from a constant flow 210, to a partially developed laminar flow 220, to a fully developed laminar flow 230. Constant flow 210 can be, for example, a flat velocity flow profile as shown but may also include some turbulent flow regions. Partially developed laminar flow 220 can be an intermediate regime where there may be reduced (or even essentially no) turbulent regions and that also has a generally peaked velocity flow profile, such as one depicted in the example of FIG. 2. In contrast, a fully developed laminar flow 230 can have a velocity flow profile that is parabolic in shape.

As used herein, when referring to flows or flow profiles that are “partially developed laminar” or “fully developed laminar,” it is understood that the present disclosure contemplates minor variations in flow profiles such that, for example, a fully developed laminar flow need not be exactly or perfectly parabolic—and therefore that a partially developed laminar flow would (incorrectly) exclude only an exact or perfect parabolic flow profile. Instead, a person of skill would be able to assess a given flow profile and characterize it as being “partially developed” laminar or “fully developed” laminar. Furthermore, there may be some degree of turbulent flow in any of the regimes (though not necessarily), with any turbulent flow generally decreasing as the laminar flow develops.

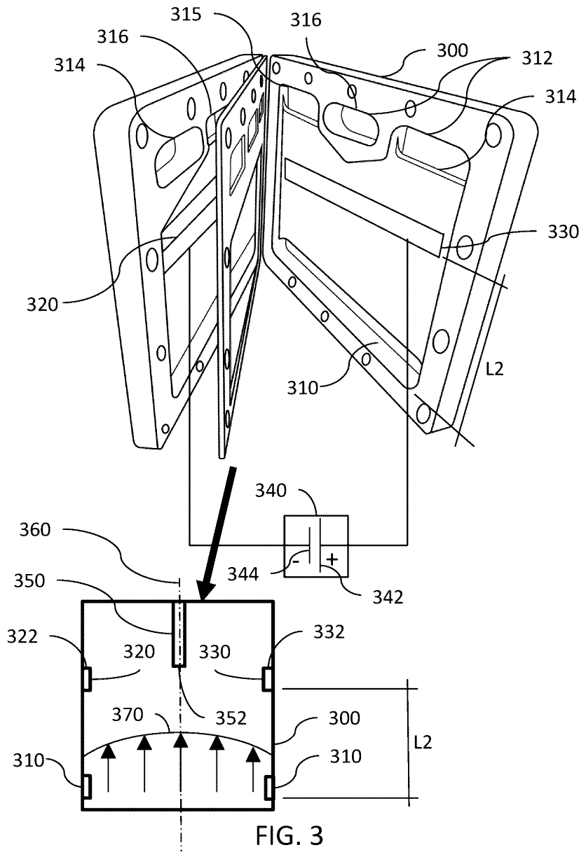

FIG. 3 is a diagram of an electrolyzer, according to an embodiment of the present disclosure. Electrolyzer 300 is depicted an open configuration to better illustrate internal components and structures of some embodiments of the disclosed electrolyzers. In some embodiments, a system can include an electrolyzer 300 having an anode 330 configured for being connected to a first pole 342 of a voltage source 340, a cathode 320 configured for being connected to a second pole 344 of the voltage source 340, a fluid inlet 310 configured to allow a flow of fluid to enter electrolyzer 300, and a fluid outlet 312 configured to allow the flow to exit electrolyzer 300. Voltage source 340 is depicted in a simplified fashion with the leads/contacts from voltage source 340 connecting to cathode 320 and anode 330 shown only to illustrate the circuit. The simplified leads and voltage source 340 can be part of the disclosed electrolyzer system but need not be part of electrolyzer 300 itself. Some embodiments can also include separator 350 that is configured to facilitate separation of fluids to first fluid outlet 316 (associated with cathode 320) and second/third fluid outlet(s) 314/315 (associated with anode 330).

The lower left inset depicts a simplified view of electrolyzer 300 along with an exemplary partially developed laminar flow. The inset shows that in some embodiments, electrolyzer 300 can be configured to cause the flow to have a flow speed profile 370 along a flow axis 360 with a relatively higher flow speed at the flow axis 360 between anode 330 and cathode 320 and where the flow speed becomes relatively lower at locations away from the flow axis 360 and more proximate anode 330 and cathode 320. In some embodiments, electrolyzer 300 can have an entrance length L2 that causes the flow speed profile to be a partially developed laminar flow when the flow reaches anode 330 or cathode 320. Entrance length L2 corresponds to a linear distance between fluid inlet 310 and cathode 320 and/or anode 330. In some embodiments L2 can be between 50 mm and 200 mm, e.g., 50, 75, 100, 125, 250, 175, or 200 mm. In some embodiments, the flow speed at the inlet can be between 1000 and 3000 liters/hr, e.g., 1000, 1500, 2000, 2160, 2500, or 3000 liters/hr. In various embodiments, the selection of entrance length L2, along with the other geometry of the electrolyzer and the flow going into fluid inlet 310, can contribute to the flow being partially laminar when reaching anode 330 or cathode 320. However, such can lead to numerous designs that have particular geometric dimensions. Accordingly, no particular dimension of the disclosed systems is considered essential.

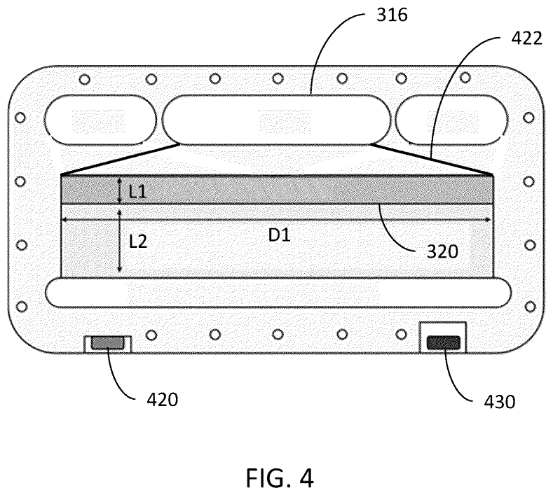

FIG. 4 is a diagram of a cathode side view of an electrolyzer illustrating fluid outlet guides over the cathode, according to an embodiment of the present disclosure. In some embodiments, the electrolyzer system can include cathode fluid guide 422 configured to direct the flow proximate the cathode 320 to first fluid outlet 316. Cathode fluid guide 422 can be a recess oriented over cathode 320 that is shaped to funnel fluid after it has passed cathode 320. Also shown in FIG. 4 are additional electrolyzer dimensions. L1 corresponds to a length of the electrode (cathode or anode) along the flow direction. In some embodiments L1 can be between 10 mm and 30 mm, e.g., 10, 15, 20, 25, or 30 mm. L1 can be the same for both the cathode 320 and anode 330, but in some embodiments may be different. D1 corresponds to a depth of the electrode in a direction longitudinal along the electrolyzer. In some embodiments D1 can be between 100 mm and 500 mm, e.g., 100, 200, 250, 300, 400, or 500 mm. Also shown in FIGS. 4 (and 5) is cathode contact 420 and anode contact 430, that can be coupled to voltage source 340.

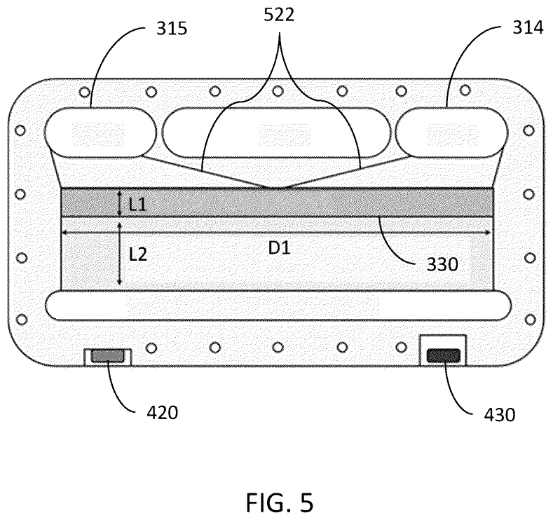

FIG. 5 is a diagram of an anode side view of an electrolyzer illustrating fluid outlet guides over the anode, according to an embodiment of the present disclosure. In some embodiments, electrolyzer 300 can also include anode fluid guide 522 configured to direct the flow proximate anode 330 to a second fluid outlet 314. Anode fluid guide 522 can be a recess oriented over anode 330 that is shaped to funnel fluid after it has passed anode 330. As shown in this embodiment, there can be two anode fluid guides with the other directing some fluid to third fluid outlet 315.

In some embodiments, as depicted by FIGS. 3-5, fluid outlet 312 can include first fluid outlet 316 and a second fluid outlet 316, the first fluid outlet 316 disposed in electrolyzer 300 to receive the flow proximate the cathode 320, the second fluid outlet 314 disposed in electrolyzer 300 to receive the flow proximate the anode 330.

In some embodiments, first fluid outlet 316 and second fluid outlet 314 can be disposed in a longitudinal direction of electrolyzer 300. This is depicted in FIGS. 3-5, where they are generally disposed lengthwise in electrolyzer 300, but in various embodiments need not be at the same height. Also shown in FIGS. 3-5 is that in some embodiments, fluid outlet 312 can also include a third fluid outlet 316, with second fluid outlet 314 and third fluid outlet 315 disposed on either side of first fluid outlet 316.

As apparent from FIG. 3, electrolyzer 300 can be elongate and substantially thinner in a transverse direction (i.e., the direction where electrolyzer 300 is narrowest) to the flow than in a longitudinal direction (i.e., the direction where electrolyzer 300 is longest). For example, some embodiments of electrolyzer 300 can be 5-20 mm in the transverse direction and 250 mm in the longitudinal direction. In some embodiments, anode 330 and cathode 320 can have a separation of between 0.5 and 12 mm, between 1 mm and 3 mm, etc. Also, some embodiments of electrolyzer 300 can have a height of between 10 mm and 70 mm along flow axis 360.

In some embodiments, electrodes such as anode 330 and/or cathode 320 can have a surface profile that is not flat. For example, this can include ripples that are perpendicular to the flow of fluid, crossed texturing, or other protrusions, etc. that can increase the surface area of the electrode. With the improvements disclosed herein, electrolyzer 300 can be applied to a number of applications. One example is desalination where the fluid can be seawater and the electrolyzer can produce a first fluid output that has a saltwater content reduced from a second fluid outlet by the separation of salt in the fluid utilizing the anode and the cathode.

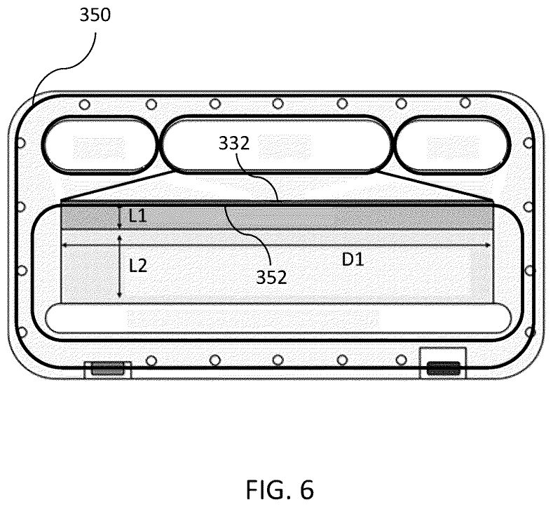

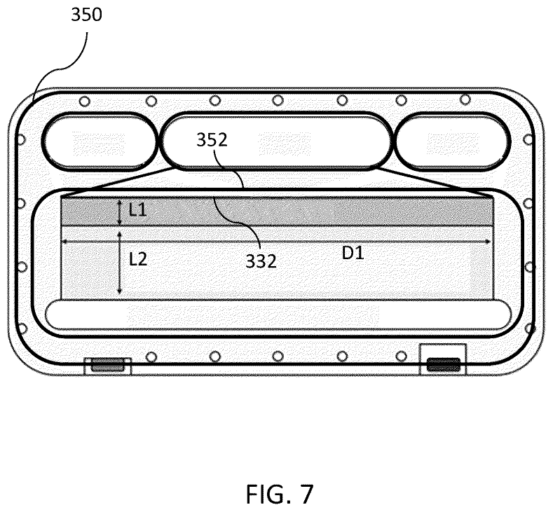

FIG. 6 is a diagram of a separator, according to an embodiment of the present disclosure. FIG. 7 is a diagram of a separator, according to another embodiment of the present disclosure. As depicted in FIG. 3, electrolyzer 300 can also include separator 350 configured to direct a first fluid output to a first fluid outlet and a second fluid output to a second fluid outlet. See also, FIG. 3 for a perspective view of an example separator 350. The separator can extend parallel to the flow axis (see inset in FIG. 3). In some embodiments, such as that shown in FIG. 6, separator 350 can have an upstream edge 352 terminating at approximately at a downstream anode edge 332 of anode 330 or at approximately a downstream cathode edge 322 of cathode 320 such that separator 350 causes at least partial separation of the flow. As used herein, the term at “approximately” a downstream/upstream edge means that separator 350 is close enough to have a quantifiable effect on the flow profile at the downstream cathode/anode edges. In contrast, were upstream edge 352 located much further downstream or upstream than the cathode/anode downstream edges, the effects of fluid separation due to separator 350 would not be noticed there. Also as used herein, the terms upstream/downstream are with reference to fluid flow. For example, with a fluid coming through fluid inlet 310 and flowing over cathode 320, the region before reaching the cathode would be “upstream” of the cathode and the region after reaching the cathode would be “downstream” of the cathode. In some embodiments, upstream edge 352 can be within 2 mm of the downstream cathode/anode edges. In other embodiments, such as that shown in FIG. 7, upstream edge 352 of separator 350 can be proximate to, and downstream of, the downstream cathode edge 322 or the downstream anode edge 332. In some embodiments, separator 350 can be a knife edge that includes a sharp edge (i.e., surfaces coming together, such as to a point/blade or nearly so) to facilitate separating the fluid.

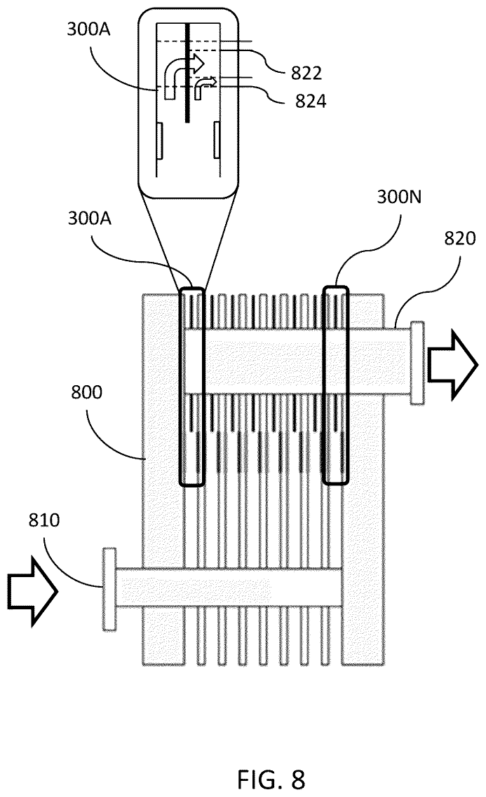

FIG. 8 is a diagram of electrolyzers arranged in a parallel stack, according to an embodiment of the present disclosure. The present disclosure contemplates that any of the disclosed embodiments of electrolyzers can be arranged in parallel stack 800. Each of the electrolyzers (300A-300N, with such representing 1, 2, 3, . . . N electrolyzers) can include features described herein (e.g., details of any of those described with reference to FIGS. 3-7). The inset above shows a simplified diagram of one electrolyzer (e.g., 300A). Furthermore, in some embodiments, systems having such a parallel stack can have each of the electrolyzers 300A-300N configured to receive portions of an input flow (e.g., water) of the fluid from a common fluid input source 810 to the fluid inlet of each of the electrolyzers. The system can also be configured to output a first fluid output (e.g., H2+water) from a first fluid outlet 822 in each of the electrolyzers and output a second fluid output (e.g., O2+water) from a second fluid outlet 824 in each of the electrolyzers.

As depicted in FIG. 8, first fluid outlet 822 and second fluid outlet 824 can be configured to direct the flow in a same direction parallel to a stacking direction of parallel stack 800 (e.g., left to right or right to left). In some embodiments, the system can be configured to cause first fluid outlet and the second fluid outlet to direct the first fluid output and second fluid output in different directions parallel to a stacking direction of the parallel stack (e.g., one fluid output goes right and the other left).

In some embodiments, a system can include a second parallel stack, where the system can be further configured to provide the first fluid output and/or second fluid output from the parallel stack to a fluid inlet of an electrolyzer in the second parallel stack. In this way, the present disclosure contemplates that the output of any number of electrolyzers can be directed to be the input of other electrolyzers (whether in a parallel stack or not). Such configurations can utilize plumbing for such connection, can include inverting alternating electrolyzers, etc.

Any of the embodiments disclosed herein can also include additional features that improve the performance/efficiency of the electrolyzer(s). For example, the electrolyzer can be constructed operate at a fluid pressure above 1 bar and at a temperature above 25 C that does not exceed the boiling point of the fluid at the fluid pressure. In some embodiments, this can include operating at a temperature of at least 100 C, at least 200 C, at a fluid pressure between 20-30 Bar to keep the fluid from boiling, etc. As such, various embodiments can include generally operating at higher pressures that permit operation at higher temperatures which may exceed the boiling point of the fluid at standard pressure. Such embodiments can be implemented by using materials with low coefficient of thermal expansion, secure seals and fasteners between components such that electrolyzer does not fail when a pressurized fluid is introduced, etc.

In some embodiments, the system can be connected to a power source such as a solar panel, a wind turbine, a water turbine, or a wave energy capture system. While such systems have advantages of being sustainable and having reduced carbon footprints, they can suffer from having intermittent or variable power production. Accordingly, the present disclosure contemplates numerous features that improve de-energizing of the anode/cathode upon power loss from voltage source 340 and also improvements for stable/continuous operation in the event of such power loss.

In some embodiments, the electrolyzer can be configured to de-energize the anode and/or the cathode within 10 seconds of turning off a power source that energizes the anode and the cathode.

In some embodiments, the system can be configured to cut power to the anode and/or the cathode when a power source providing power to the anode and/or the cathode is interrupted. In some embodiments, the system can be configured to halt the flow of fluid through the electrolyzer when a power source providing power to the anode and/or the cathode is interrupted for at least a first period of time, e.g., at least 10 minutes, at least 5 minutes, etc. In some embodiments, the system can be configured to halt heating of the electrolyzer when a power source providing power to the anode and/or the cathode is interrupted for at least a second period of time, e.g., at least two hours, at least one hour, etc. In some embodiments, the system can be configured to utilize an alternative power source to energize the anode and/or the cathode when a power source providing power to the anode and/or the cathode is interrupted. Examples of alternate power sources can include, for example, batteries, capacitors, etc.

The combinations and sub-combinations of the elements disclosed herein constitute separate embodiments and are provided as examples only. Also, the descriptions above are intended to be illustrative, not limiting. Thus, it will be apparent to one skilled in the art that modifications may be made as described without departing from the scope of the claims set out below.

In the following, further features, characteristics, and exemplary technical solutions of the present disclosure will be described in terms of items that may be optionally claimed in any combination:

Item 1: A system comprising an electrolyzer having: an anode configured for being connected to a first pole of a voltage source; a cathode configured for being connected to a second pole of the voltage source; a fluid inlet configured to allow a flow of fluid to enter the electrolyzer; and a fluid outlet configured to allow the flow to exit the electrolyzer, the electrolyzer configured to cause the flow to have a flow speed profile along a flow axis with a relatively higher flow speed at the flow axis between the anode and the cathode, and wherein the flow speed becomes relatively lower at locations away from the flow axis and more proximate the anode and the cathode, wherein the electrolyzer has an entrance length that causes the flow speed profile to be at least a partially developed laminar flow when the flow reaches the anode or the cathode.

Item 2: the system of Item 1, wherein the flow speed profile is a partially developed laminar flow.

Item 3: the system of any one of the preceding items, wherein the flow speed profile is a fully developed laminar flow.

Item 4: the system of any one of the preceding items, further comprising: a cathode fluid guide configured to direct the flow proximate the cathode to a first fluid outlet; and an anode fluid guide configured to direct the flow proximate the anode to a second fluid outlet.

Item 5: the system of any one of the preceding items, the fluid outlet comprising a first fluid outlet and a second fluid outlet, the first fluid outlet disposed in the electrolyzer to receive the flow proximate the cathode, the second outlet disposed in the electrolyzer to receive the flow proximate the anode.

Item 6: the system of any one of the preceding items, wherein the first fluid outlet and the second fluid outlet are disposed in a longitudinal direction of the electrolyzer.

Item 7: the system of any one of the preceding items, the fluid outlet further comprising a third fluid outlet with the second fluid outlet and the third fluid outlet disposed on either side of the first fluid outlet.

Item 8: the system of any one of the preceding items, wherein the electrolyzer is elongate and substantially thinner in a transverse direction to the flow than in a longitudinal direction.

Item 9: the system of any one of the preceding items, wherein the anode and the cathode have a separation of between 0.5 and 12 mm.

Item 10: the system of any one of the preceding items, wherein the separation is between 1 mm and 3 mm.

Item 11: the system of any one of the preceding items, wherein the electrolyzer has a height of between 10 mm and 70 mm along the flow axis.

Item 12: the system of any one of the preceding items, wherein the anode and/or the cathode has a surface profile that is not flat.

Item 13: the system of any one of the preceding items, wherein the surface profile includes ripples that are perpendicular to the flow of fluid.

Item 14: the system of any one of the preceding items, wherein the fluid is seawater and the electrolyzer produces a first fluid output that has a saltwater content reduced from a second fluid outlet by the separation of salt in the fluid utilizing the anode and the cathode.

Item 15: the system of any one of the preceding items, comprising an electrolyzer having: an anode configured for being connected to a first pole of a voltage source; a cathode configured for being connected to a second pole of the voltage source; a fluid inlet configured to allow a flow of fluid to enter the electrolyzer; and a fluid outlet configured to allow the flow to exit the electrolyzer, the electrolyzer configured to cause the flow to have a flow speed profile along a flow axis with a relatively higher flow speed at the flow axis between the anode and the cathode, and wherein the flow speed becomes relatively lower at locations away from the flow axis and more proximate the anode and the cathode, the electrolyzer further comprising a separator configured to direct a first fluid output to a first fluid outlet and a second fluid output to a second fluid outlet, wherein the separator extends parallel to the flow axis and has an upstream edge terminating at approximately at a downstream anode edge of the anode or at approximately a downstream cathode edge of the cathode such that the separator causes at least partial separation of the flow.

Item 16: the system of any one of the preceding items, wherein the upstream edge of the separator is proximate to, and downstream of, the downstream cathode edge or the downstream anode edge.

Item 17: the system of any one of the preceding items, wherein the separator is a knife edge that includes a sharp edge to facilitate separating the fluid.

Item 18: the system of any one of the preceding items, comprising a plurality of electrolyzers arranged in a parallel stack, each of the plurality of electrolyzers comprising: an anode configured for being connected to a first pole of a voltage source; a cathode configured for being connected to a second pole of the voltage source; a fluid inlet configured to allow a flow of fluid to enter the electrolyzer; and a fluid outlet configured to allow the flow to exit the electrolyzer, the electrolyzer configured to cause the flow to have a flow speed profile along a flow axis with a relatively higher flow speed at the flow axis between the anode and the cathode, and wherein the flow speed becomes relatively lower at locations away from the flow axis and more proximate the anode and the cathode, the system configured to: receive portions of an input flow of the fluid from a common fluid input source to the fluid inlet of each of the plurality of electrolyzers; output a first fluid output from a first fluid outlet in each of the plurality of electrolyzers; and output a second fluid output from a second fluid outlet in each of the plurality of electrolyzers.

Item 19: the system of any one of the preceding items, wherein the first fluid outlet and the second fluid outlet are configured to direct the flow in a same direction parallel to a stacking direction of the parallel stack.

Item 20: the system of any one of the preceding items, wherein the system is configured to cause the first fluid outlet and the second fluid outlet to direct the first fluid output and second fluid output in different directions parallel to a stacking direction of the parallel stack.

Item 21: the system of any one of the preceding items, further comprising a second parallel stack, wherein the system is further configured to provide the first fluid output and/or second fluid output from the parallel stack to a fluid inlet of an electrolyzer in the second parallel stack.

Item 22: the system of any one of the preceding items, comprising an electrolyzer having: an anode configured for being connected to a first pole of a voltage source; a cathode configured for being connected to a second pole of the voltage source; a fluid inlet configured to allow a flow of fluid to enter the electrolyzer; and a fluid outlet configured to allow the flow to exit the electrolyzer, the electrolyzer configured to cause the flow to have a flow speed profile along a flow axis with a relatively higher flow speed at the flow axis between the anode and the cathode, and wherein the flow speed becomes relatively lower at locations away from the flow axis and more proximate the anode and the cathode, wherein the electrolyzer is constructed operate at a fluid pressure above 1 bar and at a temperature above 25 C that does not exceed the boiling point of the fluid at a fluid pressure.

Item 23: the system of any one of the preceding items, wherein the electrolyzer is constructed to operate at the temperature being at least 100 C.

Item 24: the system of any one of the preceding items, wherein the electrolyzer is constructed to operate at the temperature being at least 200 C.

Item 25: the system of any one of the preceding items, wherein the electrolyzer is constructed to operate at the fluid pressure being between 20-30 Bar to keep the fluid from boiling.

Item 26: the system of any one of the preceding items, wherein the system is connected to a power source comprising one or more of a solar panel, a wind turbine, a water turbine, or a wave energy capture system.

Item 27: the system of any one of the preceding items, wherein the electrolyzer is configured to de-energize the anode and/or the cathode within 10 seconds of turning off a power source that energizes the anode and the cathode.

Item 28: the system of any one of the preceding items, wherein the system is configured to cut power to the anode and/or the cathode when a power source providing power to the anode and/or the cathode is interrupted.

Item 29: the system of any one of the preceding items, wherein the system is configured to halt the flow of fluid through the electrolyzer when a power source providing power to the anode and/or the cathode is interrupted for at least a first period of time.

Item 30: the system of any one of the preceding items, wherein the first period of time is at least 10 minutes.

Item 31: the system of any one of the preceding items, wherein the system is configured to halt heating of the electrolyzer when a power source providing power to the anode and/or the cathode is interrupted for at least a second period of time.

Item 32: the system of any one of the preceding items, wherein the second period of time is at least two hours.

Item 33: the system of any one of the preceding items, wherein the system is configured to utilize an alternative power source to energize the anode and/or the cathode when a power source providing power to the anode and/or the cathode is interrupted.

1. A system comprising an electrolyzer having:
an anode configured for being connected to a first pole of a voltage source;
a cathode configured for being connected to a second pole of the voltage source;
a fluid inlet configured to allow a flow of fluid to enter the electrolyzer; and
a fluid outlet configured to allow the flow to exit the electrolyzer,
wherein the electrolyzer is configured to cause the flow to have a flow speed profile along a flow axis with a relatively higher flow speed at the flow axis between the anode and the cathode,
wherein the flow speed becomes relatively lower at locations away from the flow axis and more proximate the anode and the cathode, and
wherein the electrolyzer has an entrance length that causes the flow speed profile to be at least a partially developed laminar flow when the flow reaches the anode or the cathode.

2. The system of claim 1, wherein the flow speed profile is a partially developed laminar flow.

3. The system of claim 1, further comprising:
a cathode fluid guide configured to direct the flow proximate the cathode to a first fluid outlet; and
an anode fluid guide configured to direct the flow proximate the anode to a second fluid outlet.

4. The system of claim 1, wherein the fluid outlet comprises a first fluid outlet and a second fluid outlet, wherein the first fluid outlet is disposed in the electrolyzer to receive the flow proximate the cathode, and wherein the second outlet is disposed in the electrolyzer to receive the flow proximate the anode.

5. The system of claim 4, wherein the first fluid outlet and the second fluid outlet are disposed in a longitudinal direction of the electrolyzer.

6. The system of claim 1, wherein the electrolyzer is elongate and substantially thinner in a transverse direction to the flow than in a longitudinal direction.

7. The system of claim 6, wherein the anode and the cathode have a separation of between 0.5 and 12 mm.

8. The system of claim 7, wherein the separation is between 1 mm and 3 mm.

9. The system of claim 1, wherein the electrolyzer has a height of between 10 mm and 70 mm along the flow axis.

10. The system of claim 1, wherein the anode and/or the cathode has a surface profile that is not flat.

11. The system of claim 10, wherein the surface profile includes ripples that are perpendicular to the flow of fluid.

12. The system of claim 1, wherein the fluid is seawater and the electrolyzer produces a first fluid output that has a saltwater content reduced from a second fluid outlet by the separation of salt in the fluid utilizing the anode and the cathode.

13. A system comprising an electrolyzer having:
an anode configured for being connected to a first pole of a voltage source,
a cathode configured for being connected to a second pole of the voltage source;
a fluid inlet configured to allow a flow of fluid to enter the electrolyzer;
a fluid outlet configured to allow the flow to exit the electrolyzer; and
a separator configured to direct a first fluid output to a first fluid outlet and a second fluid output to a second fluid outlet, wherein the separator extends parallel to a flow axis and has an upstream edge terminating at approximately at a downstream anode edge of the anode or approximately at a downstream cathode edge of the cathode such that the separator causes at least partial separation of the flow,
wherein the electrolyzer is configured to cause the flow to have a flow speed profile along the flow axis with a relatively higher flow speed at the flow axis between the anode and the cathode, and
wherein the flow speed becomes relatively lower at locations away from the flow axis and more proximate the anode and the cathode.

14. The system of claim 13, wherein the upstream edge of the separator is proximate to, and downstream of, the downstream cathode edge or the downstream anode edge.

15. The system of claim 13, wherein the separator is a knife edge that includes a sharp edge to facilitate separating the fluid.

16. The system of claim 13, wherein the electrolyzer is constructed to operate at a fluid pressure above 1 bar and at a temperature above 25° C. that does not exceed the boiling point of the fluid at a fluid pressure.

17. The system of claim 13, wherein the electrolyzer is elongate and substantially thinner in a transverse direction to the flow than in a longitudinal direction.

18. The system of claim 13, wherein the anode and the cathode have a separation of between 0.5 and 12 mm.

19. The system of claim 13, wherein the anode and/or the cathode has a surface profile that is not flat.

20. The system of claim 19, wherein the surface profile includes ripples that are perpendicular to the flow of fluid.
